(19) United States
(12) Patent Application Publication
(10) Pub. No.: US 2014/0375543 A1
(43) Pub. Date: Dec. 25, 2014

(54) SHARED COGNITION

(71) Applicants: Victor Ng-Thow-Hing, Sunnyvale, CA (US); Karlin Young Ju Bark, Menlo Park, CA (US); Cuong Tran, Santa Clara, CA (US)

(72) Inventors: Victor Ng-Thow-Hing, Sunnyvale, CA (US); Karlin Young Ju Bark, Menlo Park, CA (US); Cuong Tran, Santa Clara, CA (US)

(73) Assignee: HONDA MOTOR CO., LTD., Tokyo (JP)

(21) Appl. No.: 13/926,493

(22) Filed: Jun. 25, 2013

(51) Int. Cl. G06F 3/01

(52) U.S. Cl. CPC G06F 3/012; G06F 3/013; G06F 3/017
USPC 345/156

(57) ABSTRACT

A system includes at least one sensor, at least one display, and a computing device coupled to the at least one sensor and the at least one display. The computing device includes a processor, and a computer-readable storage media having computer-executable instructions embodied thereon. When executed by at least one processor, the computer-executable instructions cause the processor to receive information from at least a first occupant, identify an object based at least partially on the received information, and present, on the at least one display, a first image associated with the object to a second occupant. The first image is aligned substantially between an eye position of the second occupant and the object such that the at least one display appears to one of overlay the first image over the object and position the first image adjacent to the object with respect to the eye position of the second occupant.

### BACKGROUND

The present disclosure relates to human-machine interface (HMI) systems and, more particularly, to methods and systems for sharing information between at least a first occupant of a vehicle and a second occupant of the vehicle in a safe and efficient manner.

At least some people communicate both verbally and non-verbally. While a driver of a vehicle may be able to keep his/her attention on the road when communicating verbally with a passenger, to communicate non-verbally, the driver may divert his/her attention away from the road and towards the passenger. For example, a passenger of a vehicle may verbally instruct a driver to “Go there” while pointing at a restaurant. In response to the instruction, the driver may ask the passenger “Where?” and/or look towards the passenger to see where the passenger is pointing. Directing the driver's gaze away from the road while the driver is operating the vehicle may be dangerous. Accordingly, in at least some known vehicles, communication between a driver and a passenger of a vehicle may be generally limited to verbal communication.

### BRIEF SUMMARY

In one aspect, a method is provided for sharing information between at least a first occupant of a vehicle and a second occupant of the vehicle. The method includes receiving information from the first occupant, identifying an object based at least partially on the received information, and presenting, on a display, a first image associated with the object to the second occupant. The first image is aligned substantially between an eye position of the second occupant and the object such that the display appears to one of overlay the first image over the object and position the first image adjacent to the object with respect to the eye position of the second occupant.

In another aspect, one or more computer-readable storage media are provided. The one or more computer-readable storage media has computer-executable instructions embodied thereon. When executed by at least one processor, the computer-executable instructions cause the processor to receive information from at least a first occupant, identify an object based at least partially on the received information, and present, on a display, a first image associated with the object to a second occupant. The first image is aligned substantially between an eye position of the second occupant and the object such that the display appears to one of overlay the first image over the object and position the first image adjacent to the object with respect to the eye position of the second occupant.

In yet another aspect, a system is provided. The system includes at least one sensor, at least one display, and a computing device coupled to the at least one sensor and the at least one display. The computing device includes a processor, and a computer-readable storage media having computer-executable instructions embodied thereon. When executed by at least one processor, the computer-executable instructions cause the processor to receive information from at least a first occupant, identify an object based at least partially on the received information, and present, on the at least one display, a first image associated with the object associated with the object to a second occupant. The first image is aligned substantially between an eye position of the second occupant and the object such that the at least one display appears to one of overlay the first image over the object and position the first image adjacent to the object with respect to the eye position of the second occupant.

The features, functions, and advantages described herein may be achieved independently in various embodiments of the present disclosure or may be combined in yet other embodiments, further details of which may be seen with reference to the following description and drawings.

### BRIEF DESCRIPTION OF THE DRAWINGS

FIG. 1 is a schematic illustration of an exemplary human-machine interface (HMI) system environment;

FIG. 2 is a schematic illustration of an exemplary computing device that may be used in the HMI system environment described in FIG. 1;

FIG. 3 is a flowchart of an exemplary method that may be implemented by the computing device shown in FIG. 2.

Although specific features of various implementations may be shown in some drawings and not in others, this is for convenience only. Any feature of any drawing may be referenced and/or claimed in combination with any feature of any other drawing.

### DETAILED DESCRIPTION OF THE INVENTION

The present disclosure relates to human-machine interface (HMI) systems and, more particularly, to methods and systems for sharing information between at least a first occupant of a vehicle and a second occupant of the vehicle in a safe and efficient manner. In one embodiment, a system includes at least one sensor, at least one display, and a computing device coupled to the at least one sensor and the at least one display. The computing device includes a processor, and a computer-readable storage media having computer-executable instructions embodied thereon. When executed by at least one processor, the computer-executable instructions cause the processor to receive information from the first occupant, identify an object based at least partially on the received information, and present, on the at least one display, a first image associated with the object to the second occupant. The first image is aligned substantially between an eye position of the second occupant and the object such that the at least one display appears to either overlay the first image over the object and/or position the first image proximate to the object as viewed by at least the second occupant.

As used herein, an element or step recited in the singular and preceded with the word “a” or “an” should be understood as not excluding plural elements or steps, unless such exclusion is explicitly recited. Furthermore, references to one “implementation” or one “embodiment” of the subject matter described herein are not intended to be interpreted as excluding the existence of additional implementations that also incorporate the recited features. The following detailed description of implementations consistent with the principles of the disclosure refers to the accompanying drawings. In the absence of a contrary representation, the same reference numbers in different drawings may identify the same or similar elements.

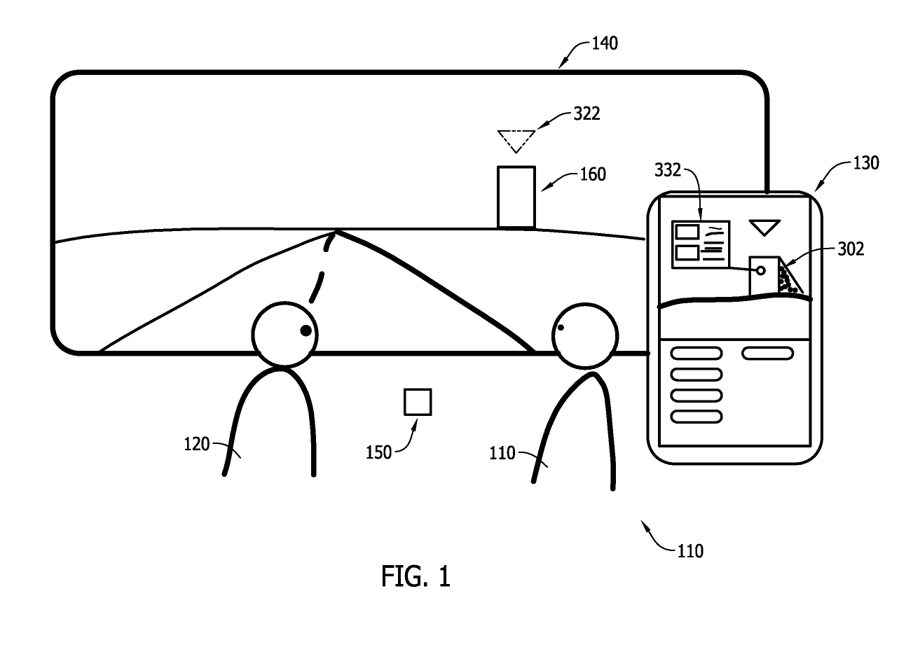

FIG. 1 is a schematic illustration of an exemplary HMI system environment 100. In the exemplary embodiment, environment 100 may be in any vessel, aircraft, and/or vehicle including, without limitation, an automobile, a truck, a boat, a helicopter, and/or an airplane. In at least some implementations, a plurality of occupants (e.g., at least one passenger 110 and a driver 120) are positioned within environment 100. For example, in one implementation, passenger 110 and driver 120 are seated in the cabin of a vehicle.

In the exemplary embodiment, environment 100 includes a first display 130 that is configured to present a first screen or image, and a second display 140 that is configured to present a second screen or image. In at least some implementations, first display 130 is associated with and/or oriented to present the first image to a first occupant (e.g., passenger 110), and second display 140 is associated with and/or oriented to present the second image to a second occupant (e.g., driver 120). In at least some implementations, first display 130 is a monitor that is mounted on a dashboard and/or is on a tablet, smartphone, or other mobile device. In at least some implementations, second display 140 is a heads-up display (HUD) that is projected onto a windshield of a vehicle. As used herein, a HUD is any display that includes an image that is at least partially transparent such that driver 120 can selectively look at and/or through the image while operating the vehicle. Alternatively, first display 130 and/or second display 140 may be any type of display that enables the methods and systems to function as described herein.

In the exemplary embodiment, environment 100 includes at least one sensor 150 that is configured and/or oriented to detect and/or to determine a position of at least a part of an object 160 that is eternal to the vehicle to enable a road scene to be determined and/or generated. Object 160 may be a standalone object (or group of objects), such as a building and/or a tree, or may be a portion of an object, such as a door of a building, a portion of a road, and/or a license plate of a car. As used herein, the term “road scene” may refer to a view in the direction that the vehicle is traversing and/or oriented (e.g., front view). Accordingly, in at least some implementations, the generated road scene is substantially similar to and/or the same as the driver's view.

Additionally, in the exemplary embodiment, sensor 150 is configured and/or oriented to detect and/or determine a position of at least a part of passenger 110 and/or driver 120 inside the vehicle to enable a field of view or line of sight of that occupant to be determined For example, in one implementation, sensor 150 is oriented to detect an eye position and/or a hand position associated with passenger 110 and/or driver 120. As used herein, the term “eye position” may refer to a position and/or orientation of an eye, a cornea, a pupil, an iris, and/or any other part on the head that enables the methods and systems to function as described herein. As used herein, the term “hand position” may refer to a position and/or orientation of a hand, a wrist, a palm, a finger, a fingertip, and/or any other part adjacent to the end of an arm that enables the methods and systems to function as described herein. Additionally or alternatively, sensor 150 may be configured and/or oriented to detect and/or determine a position of at least a part of a prop, a stylus, and/or a wand associated with passenger 110 and/or driver 120. Any number of sensors 150 may be used to detect any combination of objects 160, passengers 110, and/or driver 120 that enables the methods and systems to function as described herein.

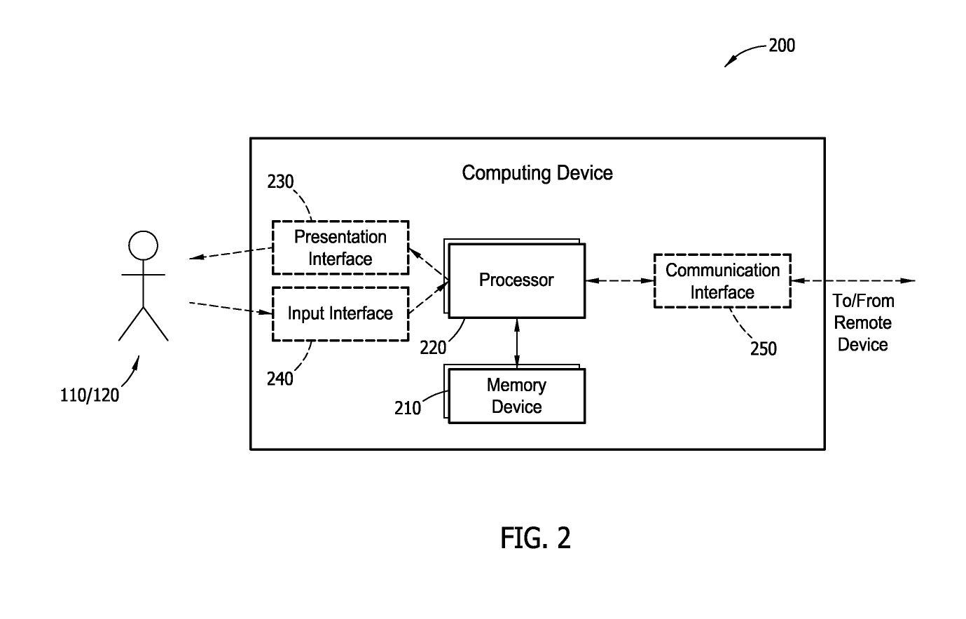

FIG. 2 is a schematic illustration of a computing device 200 that is coupled to first display 130, second display 140, and/or sensor 150. In the exemplary embodiment, computing device 200 includes at least one memory device 210 and a processor 220 that is coupled to memory device 210 for executing instructions. In some implementations, executable instructions are stored in memory device 210. In the exemplary embodiment, computing device 200 performs one or more operations described herein by programming processor 220. For example, processor 220 may be programmed by encoding an operation as one or more executable instructions and by providing the executable instructions in memory device 210.

Processor 220 may include one or more processing units (e.g., in a multi-core configuration). Further, processor 220 may be implemented using one or more heterogeneous processor systems in which a main processor is present with secondary processors on a single chip. In another illustrative example, processor 220 may be a symmetric multi-processor system containing multiple processors of the same type. Further, processor 220 may be implemented using any suitable programmable circuit including one or more systems and microcontrollers, microprocessors, reduced instruction set circuits (RISC), application specific integrated circuits (ASIC), programmable logic circuits, field programmable gate arrays (FPGA), and any other circuit capable of executing the functions described herein.

In the exemplary embodiment, memory device 210 is one or more devices that enable information such as executable instructions and/or other data to be stored and retrieved. Memory device 210 may include one or more computer readable media, such as, without limitation, dynamic random access memory (DRAM), static random access memory (SRAM), a solid state disk, and/or a hard disk. Memory device 210 may be configured to store, without limitation, application source code, application object code, source code portions of interest, object code portions of interest, configuration data, execution events and/or any other type of data.

In the exemplary embodiment, computing device 200 includes a presentation interface 230 (e.g., first display 130 and/or second display 140) that is coupled to processor 220. Presentation interface 230 is configured to present information to passenger 110 and/or driver 120. For example, presentation interface 230 may include a display adapter (not shown) that may be coupled to a display device, such as a cathode ray tube (CRT), a liquid crystal display (LCD), an organic LED (OLED) display, and/or an “electronic ink” display. In some implementations, presentation interface 230 includes one or more display devices.

In the exemplary embodiment, computing device 200 includes a user input interface 240 (e.g., sensor 150) that is coupled to processor 220. User input interface 240 is configured to receive input from passenger 110 and/or driver 120. User input interface 240 may include, for example, a keyboard, a pointing device, a mouse, a stylus, a touch sensitive panel (e.g., a touch pad or a touch screen), a gyroscope, an accelerometer, a position detector, and/or an audio user input interface. A single component, such as a touch screen, may function as both a display device of presentation interface 230 and user input interface 240.

Computing device 200, in the exemplary embodiment, includes a communication interface 250 coupled to processor 220. Communication interface 250 communicates with one or more remote devices. To communicate with remote devices, communication interface 250 may include, for example, a wired network adapter, a wireless network adapter, and/or a mobile telecommunications adapter.

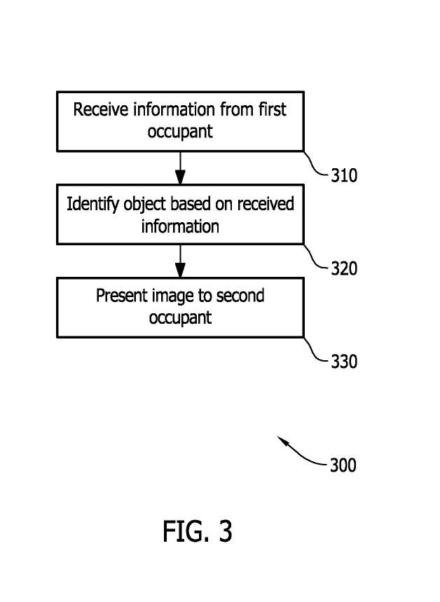

FIG. 3 is a flowchart of an exemplary method 300 that may be implemented by computing device 200 (shown in FIG. 2). In the exemplary embodiment, at least one object 160 (shown in FIG. 1) outside and/or external to the vehicle is detected and/or identified to enable a road scene to be populated with at least one virtual object 302 (shown in FIG. 1) associated with the detected object 160. For example, in one implementation, a virtual building may be populated on the road scene based on a physical building detected by sensor 150.

In the exemplary embodiment, the road scene is presented on first display 130, and input and/or information associated with the road scene is detected and/or received 310 from passenger 110. In the exemplary embodiment, an object 160 external to the vehicle is determined and/or identified 320 based at least partially on the received information. In some implementations, sensors 150 detect and/or computing device 200 receives 310 information from passenger 110 based on any combination of human-computer interaction including, without limitation, hand position and/or movement, eye position, movement, and/or orientation, and/or speech.

In some implementations, object 160 and/or a characteristic or property of object 160 is identified 320 based at least partially on a hand movement (pointing, circling, twirling, etc.) of passenger 110. For example, in one implementation, passenger 110 touches first display 130 to identify a virtual object 302, which, in at least some implementations, is associated with a detected object 160. Additionally or alternatively, an object 160 is identified 320 based at least partially on a line-of-sight extended and/or extrapolated from an eye position of passenger 110, through a hand position of passenger 110, and/or to object 160.

In some implementations, object 160 and/or a characteristic or property of object 160 is identified 320 based at least partially on a hand movement and/or a relative positioning of both hands of passenger 110. For example, in one implementation, a size of and/or a distance to an object 160 may be determined based on a distance between the hands of passenger 110.

In some implementations, a task and/or operation may be determined based on a position of at least one hand. For example, in one implementation, an open palm and/or an open palm moving back and forth may be identified as an instruction to stop the vehicle. Any meaning may be determined and/or identified based on any characteristic or property of the hand position and/or movement including, without limitation, a location, a gesture, a speed, and/or a synchronization of the hand movement. A gesture may include any motion that expresses or helps express thought, such as a trajectory of the hand, a position of the hand, and/or a shape of the hand.

In some implementations, object 160 and/or a characteristic or property of object 160 is identified 320 based at least partially on a voice and/or speech of passenger 110. For example, in one implementation, a type of object 160 may be determined based on a word spoken by passenger 110. Any meaning may be determined and/or identified based on any characteristic or property of the voice and/or speech.

After object 160 is identified 320, in the exemplary embodiment, an icon or image 322 (shown on FIG. 1) is presented 330 on second display 140 to identify and/or indicate object 160 to driver 120. For example, in one implementation, image 322 is an arrow, a frame, and/or a block projected on second display 140. Alternatively, image 322 may have any shape, size, and/or configuration that enables the methods and systems to function as described herein.

In the exemplary embodiment, a position and/or orientation of image 322 is determined based at least partially on an eye position of driver 120, a head position of driver 120, and/or a position of object 160. For example, in at least some implementations, a line-of-sight associated with driver 120 is determined based at least partially on the eye position, the head position, and/or the position of object 160, and the image is positioned substantially in the line-of-sight between the eye position and/or the head position and the position of object 160 such that, from the driver's perspective, the image appears to lay over and/or be positioned proximate to object 160. In at least some implementations, a position and/or orientation of image 322 is adjusted and/or a second image (not shown) is presented 330 on second display 140 based at least partially on a change in an eye position, a head position, an absolute position of object 160, and/or a relative position of object 160 with respect to driver 120 and/or the vehicle.

In some implementations, computing device 200 determines and/or identifies a route (e.g., driving instructions) based on user input provided by passenger 110, and presents the route on the second display 330 such that an image 322 substantially follows a road and/or combination of roads along the route. In some implementations, computing device 200 includes GPS sensors and/or is coupled to a cloud-based solution (e.g., address database indexed by geo-location).

For example, in one implementation, passenger 110 traces a route on first display 130 (e.g., on a display mounted on the dashboard and/or on a tablet or smartphone), and computing device 200 identifies the route based on the traced route. In another implementation, passenger 110 gestures a route using hand movement, and computing device 200 identifies the route based on the gestured route. In yet another implementation, passenger 110 dictates a route using speech, and computing device 200 determines and/or identifies the route based on the dictated route. Additionally or alternatively, the route may be determined and/or presented using any combination of human-computer interaction including, without limitation, hand position and/or movement, eye position, movement, and/or orientation, and/or speech.

In the exemplary embodiment, any type of information may be populated on and/or cleared from first display 130 and/or second display that enables the methods and systems to function as described herein. For example, in one implementation, a window 332 including information (e.g., name, address, prices, reviews) associated with object 302 may be selectively presented on first display 130 and/or second display 140. Additionally or alternatively, passenger 110 may “draw” or “write” on second display 140 by interacting with sensors 150 and/or computing device 200. In at least some implementations, driver 120 may also populate and/or clear first display 130 and/or second display 140 in a similar manner as passenger 110. For example, in one implementation, driver 120 makes a “wiping” gesture by waving a hand in front of driver 120 to clear or erase at least a portion of first display 130 and/or second display 140.

The methods and systems described herein may be implemented using computer programming or engineering techniques including computer software, firmware, hardware or any combination or subset thereof, wherein the technical effects may be achieved by performing at least one of the following steps: a) receiving information from a first occupant; b) identifying an object based at least partially on the received information; c) presenting a first image associated with the object to the second occupant; d) detecting a change in one of an eye position and a head position of the second occupant; and e) presenting a second image associated with the object to the second occupant based on the change in the one of the eye position and the head position.

The present disclosure relates to human-machine interface (HMI) systems and, more particularly, to methods and systems for sharing information between a first occupant of a vehicle and a second occupant of the vehicle. The methods and systems described herein enable a passenger of the vehicle to “share” a road scene with a driver of the vehicle, and to populate the road scene with information to communicate with the driver. For example, the passenger may identify a building (e.g., a hotel or restaurant), provide driving directions to a desired location, and/or share any other information with the driver.

Exemplary embodiments of an HMI system are described above in detail. The methods and systems are not limited to the specific embodiments described herein, but rather, components of systems and/or steps of the method may be utilized independently and separately from other components and/or steps described herein. Each method step and each component may also be used in combination with other method steps and/or components. Although specific features of various embodiments may be shown in some drawings and not in others, this is for convenience only. Any feature of a drawing may be referenced and/or claimed in combination with any feature of any other drawing.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method of sharing information between at least a first occupant of a vehicle and a second occupant of the vehicle, the method comprising:
receiving information from the first occupant;
identifying an object based at least partially on the received information; and
presenting, on a display, a first image associated with the object to the second occupant, wherein the first image is aligned substantially between an eye position of the second occupant and the object such that the display appears to one of overlay the first image and position the first image adjacent to the object with respect to the eye position of the second occupant.

2. A method in accordance with claim 1, wherein receiving information further comprises detecting a hand position of the first occupant, and wherein associating the information with an object further comprises extending a line-of-sight from an eye position of the first occupant towards the hand position of the first occupant to determine the object external to the vehicle.

3. A method in accordance with claim 1, wherein receiving the information further comprises detecting a hand movement of the first occupant, and wherein associating the information with an object further comprises determining a meaning associated with the hand movement.

4. A method in accordance with claim 1, wherein receiving the information further comprises detecting a relative positioning of a first hand and a second hand of the first occupant, and wherein associating the information with an object further comprises determining a meaning associated with the relative positioning of the first hand and the second hand.

5. A method in accordance with claim 1, wherein receiving the information further comprises detecting a speech of the first occupant, and wherein associating the information with an object further comprises determining a meaning associated with the speech.

6. A method in accordance with claim 1 further comprising:
detecting a change in one of an eye position and a head position of the second occupant; and
presenting, on the display, a second image associated with the object to the second occupant based on the change in the one of the eye position and the head position.

7. A method in accordance with claim 1, wherein receiving information from the first occupant further comprises receiving a traced route from the first occupant, wherein identifying an object further comprises identifying a road associated with the traced route, and wherein presenting a first image associated with the object further comprises aligning the first image substantially between the eye position of the second occupant and the road such that the first image appears to follow the road with respect to the eye position of the second occupant.

8. One or more computer-readable storage media having computer-executable instructions embodied thereon, wherein, when executed by at least one processor, the computer-executable instructions cause the processor to:
receive information from at least a first occupant;
identify an object based at least partially on the received information; and
present, on a display, a first image associated with the object to a second occupant, wherein the first image is aligned substantially between an eye position of the second occupant and the object such that the display appears to one of overlay the first image over the object and position the first image adjacent to the object with respect to the eye position of the second occupant.

9. One or more computer-readable storage media in accordance with claim 8, wherein the computer-executable instructions further cause the processor to
detect a hand position of the first occupant; and
extend a line-of-sight from an eye position of the first occupant towards the hand position of the first occupant to determine the object external to the vehicle.

10. One or more computer-readable storage media in accordance with claim 8, wherein the computer-executable instructions further cause the processor to:
detect a hand movement of the first occupant; and
determine a meaning associated with the hand movement.

11. One or more computer-readable storage media in accordance with claim 8, wherein the computer-executable instructions further cause the processor to:
detect a relative positioning of a first hand and a second hand of the first occupant; and
determine a meaning associated with the relative positioning of the first hand and the second hand.

12. One or more computer-readable storage media in accordance with claim 8, wherein the computer-executable instructions further cause the processor to:
detect a speech of the first occupant; and
determine a meaning associated with the speech.

13. One or more computer-readable storage media in accordance with claim 8, wherein the computer-executable instructions further cause the processor to detect one of an eye position and a head position of the second occupant to determine a line-of-sight associated with the second occupant.

14. One or more computer-readable storage media in accordance with claim 8, wherein the computer-executable instructions further cause the processor to:
receive a traced route from the first occupant;
identify a road associated with the traced route; and
align the first image substantially between the eye position of the second occupant and the road such that the first image appears to follow the road with respect to the eye position of the second occupant.

15. A system comprising:
at least one sensor;
at least one display; and
a computing device coupled to the at least one sensor and the at least one display, the computing device comprising a processor, and a computer-readable storage media having computer-executable instructions embodied thereon, wherein, when executed by at least one processor, the computer-executable instructions cause the processor to:
receive information from at least a first occupant;
identify an object based at least partially on the received information; and
present, on the at least one display, a first image associated with the object to a second occupant, wherein the first image is aligned substantially between an eye position of the second occupant and the object such that the at least one display appears to one of overlay the first image over the object and position the first image adjacent to the object with respect to the eye position of the second occupant.

16. A system in accordance with claim 15, wherein the computer-executable instructions further cause the processor to:
detect, using the at least one sensor, a hand position of the first occupant; and
extend a line-of-sight from an eye position of the first occupant towards the hand position of the first occupant to determine the object external to the vehicle.

17. A system in accordance with claim 15, wherein the computer-executable instructions further cause the processor to:
detect, using the at least one sensor, a hand movement of the first occupant; and
determine a meaning associated with the hand movement.

18. A system in accordance with claim 15, wherein the computer-executable instructions further cause the processor to:
detect, using the at least one sensor, a relative positioning of a first hand and a second hand of the first occupant; and
determine a meaning associated with the relative positioning of the first hand and the second hand.

19. A system in accordance with claim 15, wherein the computer-executable instructions further cause the processor to:
detect, using the at least one sensor, a speech of the first occupant; and
determine a meaning associated with the speech.

20. A system in accordance with claim 15, wherein the computer-executable instructions further cause the processor to:
receive a traced route from the first occupant;
identify a road associated with the traced route; and
align the first image substantially between the eye position of the second occupant and the road such that the first image appears to follow the road with respect to the eye position of the second occupant.
